(19) United States
(12) Patent Application Publication
(10) Pub. No.: US 2010/0319626 A1
(43) Pub. Date: Dec. 23, 2010

(54) ANIMAL BED DEVICE

(76) Inventor: Thomas Williams, Bromsgrove (GB)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/797,779

(22) Filed: Jun. 10, 2010

(30) Foreign Application Priority Data
Jun. 12, 2009 (GB) 0910181.7

(51) Int. Cl. A01K 1/03; A01K 29/00

(52) U.S. Cl. 119/500; 119/28.5; 119/501

(57) ABSTRACT

A bed for an animal, comprising a support member; a cover for at least part of the support member, to define and at least partially enclose a space above the support member for occupation by the animal; means for drawing air from the occupation space, and filtration means for removing at least some airborne matter from the withdrawn air.

### BACKGROUND

This invention relates to a device which provides an animal bed, suitable for a domestic animal such as a dog or cat (although it is to be appreciated that it may be suitable for other animals). A preferred embodiment of the invention provides not only an animal bed but also a container in which an animal may be carried in circumstances where the animal must be constrained within an enclosed space.

One problem of modern life is that increasing numbers of people are becoming allergic to substances commonly to be found in the home. In many cases the problem is dust mites whose faeces are allergenic: dust mites mainly live in soft furnishings particularly bedding. A particular problem in a household which has one or more pet dogs and/or cats is the dander from the animal(s), i.e. microscopic flakes of dead skin, the animal(s) fur or hair, secretions from when the animal grooms itself, and so forth. Even if an animal is confined to a single room of a house, the dander can be carried throughout a house in the air and by movement of people therein. Many domestic animals have a bed or sleeping area which is within the main living area of a house (rather than in an outhouse or the like) and this provides a ‘hot spot’ from which accumulated dander can spread through the house. Frequent and thorough cleaning of the animals' sleeping area is of assistance in reducing the problem, but in many cases animals are free to move through most or all of the house, and it is virtually impossible to clean an entire house with the thoroughness and frequency necessary to eliminate the problem.

### SUMMARY

With the object of addressing the above problem, according to one aspect of the present invention, we provide a bed for an animal, comprising a support member for the animal; a cover for at least part of the support member, to define and at least partially enclose an occupation space for the animal above the support member; means for drawing air from the occupation space; and filtration means for removing at least some air-borne matter from the withdrawn air.

A bed in accordance with the invention tackles the problem of animal-originating allergens by filtration to remove particulate matter from the air in the immediate vicinity of the animal's bed, reducing spread of the particulate matter from this source. It cannot, of course, have any effect on the spread of allergens by an animal free to roam through a house, but since the animal's bed is a ‘hot spot’ from which allergens can spread through a house, even if the animal is confined to the room in which its bed is kept, to reduce spread of allergens from that source is beneficial in tackling the overall problem.

The filtration means, by which the air drawn from the space occupied by an animal in the bed is filtered, must be extremely effective if it is to remove dander from the air. Therefore, a number of filter stages may be provided, for example at least some and preferably all of the following:

firstly, a membrane filter able to remove pet hair and large dust particles from air passing through the filter;

secondly, an electrostatic filter able to remove smaller dander particles and larger pollen particles;

thirdly, a HEPA filter able to remove even smaller dander particles, dust mite faeces, and pollen; and

finally, a carbon filter able to remove odours.

A filter element incorporating the above stages may have an adhesive quality to collect any stray hairs or the like; it may also have an anti-bacterial quality.

Air withdrawn from the animal occupation space of the bed and having passed through the filter may be returned to the animal occupation space, at a part thereof remote from the part at which it has been withdrawn, e.g. the opposite side of the animal occupation space.

For example, ducts for air withdrawal and return may communicate with the animal occupation space in the vicinity of an upper surface of the support member on which the animal may rest. The support member may carry a cushion or like element of a material and construction which is comfortable for an animal to rest upon.

The animal bed may comprise a first part which includes the support member and cover (and hence affords the space to be occupied by an animal), and a second part to which the first part is removably connected and which includes the means for drawing air from the occupation space and the filtration means.

The first part of the bed preferably connects to the second part on the top thereof, and may be slidable into engagement therewith. The first part of the bed may be provided with passages for flow of air to and from the animal occupation space, which passages register with passages in the second part which lead to and from the means for drawing air from the occupation space and the filtration means, when the first part is fitted to the second part.

The first part may be provided with a door which is able to be moved between open and closed positions in relation to the support member and cover, and which, when in its closed position, is effective to constrain an animal within the occupation space.

It will be appreciated that with such provision the first part of the bed may be used as an animal-carrying container, if the animal is to be transported under circumstances in which it cannot remain out in the open. Such circumstances might arise if an animal is to be taken on public transport or if it is to be taken to a veterinary practice.

The door may be completely removable from the first part of the bed when it is not required to constrain the animal for transportation. In this case, the second part of the bed may provide for storage of the door so that it is kept to hand and readily accessible. To facilitate its use as animal transportation container, the first part of the bed may be provided with a handle formation.

For drawing air from the occupation space of the bed (and if required returning it thereto), the second part of the bed may be provided with at least one fan. Preferably, there are two fans having different capacities for causing flow of air of which a first fan provides a relatively small air flow and operates very quietly. Such a fan may operate even when an animal is occupying the bed. A second fan may be provided to cause a greater flow of air, for cleaning the occupation space when an animal is not present.

A sensing device or devices may be provided, for determining whether an animal is occupying the bed, and for causing operation of the first and second fans in accordance with whether the presence of an animal in the occupation space of the bed is detected. Such a sensing device may be operated mechanically e.g. in response to the weight of an animal on the support member or a part thereof, or a non-contact sensing device or devices may be utilised to detect the entering and leaving of the occupation space by an animal.

It is envisaged that when an animal enters the occupation space of the bed, the first fan, which provides a relatively low air flow, is caused to operate, and remain in operation as long as the bed is occupied. When the animal leaves the occupation space of the bed, the second fan which provides a higher air flow may be started while the first-mentioned fan is stopped, the second fan operating for a timed period e.g. 15 minutes to draw accumulated dander from the support member region and any bedding material thereon.

When the first part of the bed is removed from the second part, the second part may be operable in which case it acts as an air cleaner, drawing air from the region around the second part and returning it thereto.

### BRIEF DESCRIPTION OF THE DRAWINGS

The invention will now be described by way of example with reference to the accompanying drawings, of which:

FIG. 1 is a perspective view of an animal bed in accordance with the invention;

FIG. 2 is a cross-section lengthways of the animal bed;

FIG. 3 is an underneath view of a first part of the bed;

FIG. 4 is a diagrammatic plan view of a second part of the bed;

FIG. 5 is a plan view of operative components within the second part of the bed.

### DETAILED DESCRIPTION

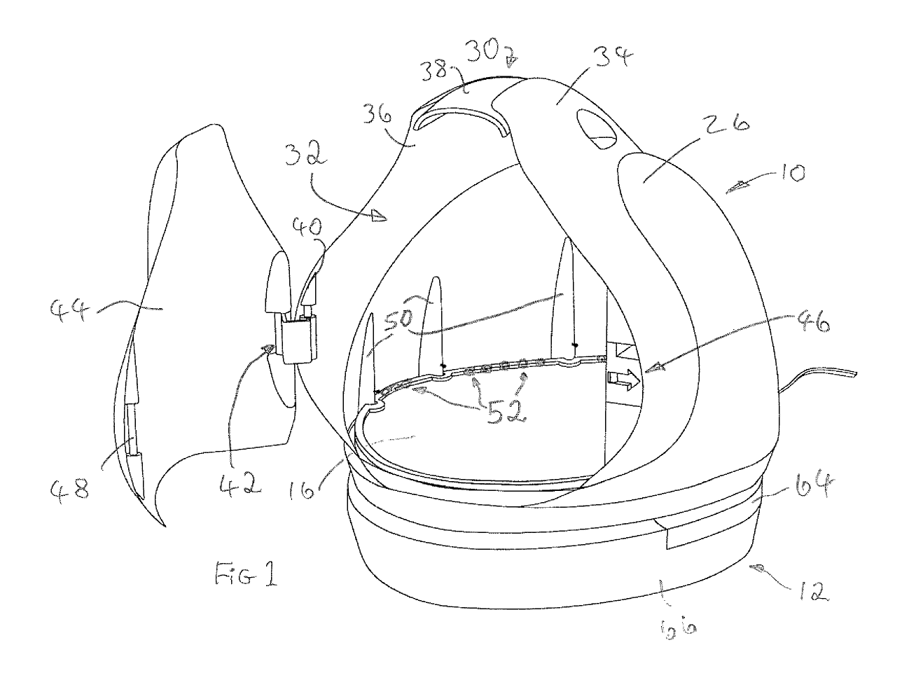

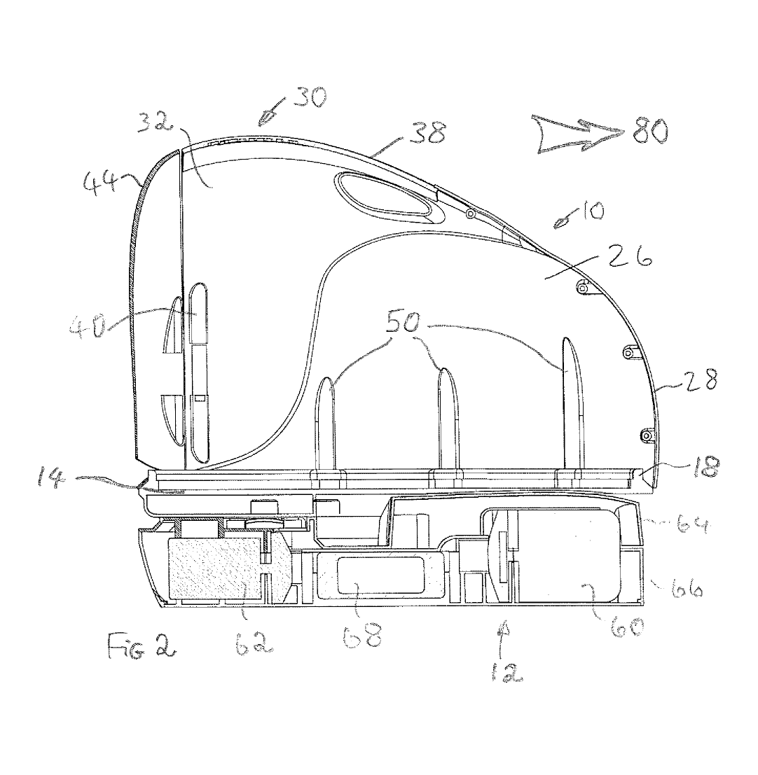

Referring firstly to FIGS. 1 and 2 of the drawings, these show an embodiment of pet bed comprising a first, upper, part indicated generally at 10 and a second, lower, part indicated generally at 12. The two parts are removably connected to one another as described hereafter. The lower part has an undersurface which is flat or has formations enabling it to be placed on a floor or other flat surface to stand stably.

The first part 10 of the bed comprises a support member 14 with a generally flat upwardly-presented support surface 16 and a peripheral rim 18. In plan view the shape of the support member 14 is as seen in FIGS. 3 to 5, being somewhat egg shaped with a curved front end indicated at 20 in FIG. 3 and a gothic-arch shaped rear end 22 with an apex 24. To the support member 14 is secured a superstructure or cover 26 whose shape is a number of complex curves, rising from a rear wall 28 fitting closely to the rim 18 of the support member 14 to a crest 30 and a front opening 32. The cover 26 comprises two side components 34, 36 of moulded opaque plastics material secured to one another with a central component 38 which may be of a transparent or translucent plastics material, therebetween these component 34, 36, 38 being secured to one another in any suitable manner. Hence the cover extends over all the support member 14 with the exception of a small part at the front end 20 thereof, to define a space which is large enough for occupation by a cat or small dog.

The component 36 of the cover 26 is provided, at its front end, with a mounting 40 for a hinge arrangement indicated generally at 42, by which a door 44 is pivotably secured to the component 36. The door 44 is shown in FIG. 1 in an open position and the hinge 42 enables its to pivot to a closed position in which it substantially closes the opening 32 at the front of the cover. It may be held in the closed position by a catch mechanism indicated generally at 46 co-operable with a member 48 on the door 44, remote from the hinge 42.

Preferably the hinge 42 provides for complete detachment of the door 44 from the cover 26 when required.

Internally, each of the side components 34, 36 is provided with upwardly extending reinforcing ribs as visible at 50 in the interior of the component 36; at the lowermost end of each of these ribs there is an upwardly-extending opening for receiving a respective locating pin by which the cover is aligned and connected to the support member 14, being secured thereto by a detachable clip, not shown.

Visible in FIG. 1 are a number of apertures 52 which communicate with an internal duct, not shown, at the rim of the support member which opens downwardly at 54 (FIG. 3). Corresponding apertures and ducts are provided at the opposite side of the support member 14, whose communicating duct opens downwardly at 56 as shown in FIG. 3.

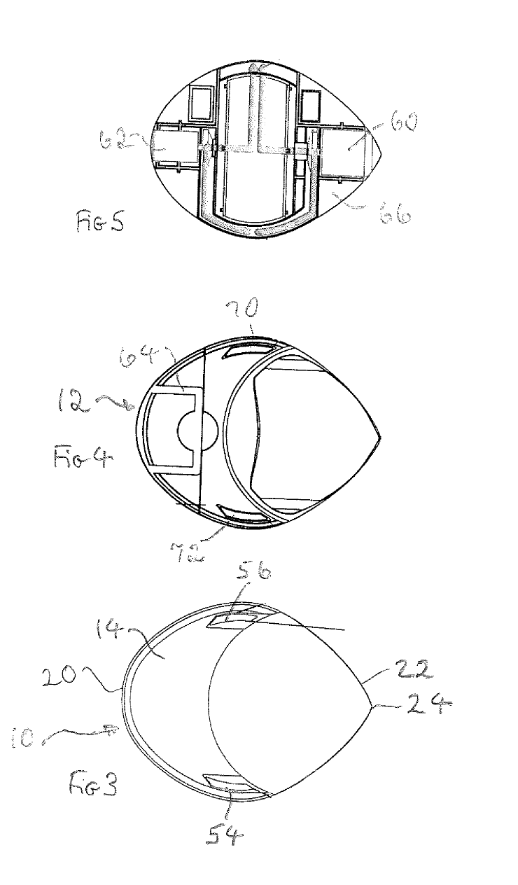

The second part 12 of the bed is provided with two electric motors 60, 62 which drive respective fans. These are disposed respectively adjacent the rear and front of the second part 12, supported within a body comprising upper and lower moulded plastics components 64, 66. A filter assembly 68 extends transversely of the second part 12, and preferably is of the construction above described, providing for filtration of air to HEPA standard by a number of filtration stages. The second part 12 is provided with suitable ducting not herein described in detail, having upwardly facing duct inlet/outlet formations seen at 70, 72 in FIG. 4, which openings, when the first part of the bed is fitted to the bottom part, register with the duct openings 54, 56 respectively in the first part. The arrangement of the electric motors 60 and 62 and their respective fans is such that operation of either motor is able to cause air to be drawn from the interior space of the first part, which can be occupied by an animal, by way of the apertures as 52 (but at the opposite side of the support member) and through the ducting leading to the duct opening 56 and through the filtration assembly 68 for cleaning. Thence, air is directed to the duct opening 70 registering with the duct opening 54 in the support member 14, and to the openings 52 to re-enter the animal occupation space of the first part 10.

The motor 60 preferably is a more powerful motor than the motor 62. The motor 62 may be operable when the first part is occupied by an animal, to cause a relatively low air flow under these conditions. When the animal leaves the occupation space of the first part, the motor 60 may be brought into operation for a set time, e.g. 15 minutes, to effect cleaning of the occupation space by a higher air flow. Particularly the motor 60, and preferably also the motor 62, preferably causes air to be returned to the first part under sufficient pressure to ensure that it can emerge from the apertures 52 even if one or more of them are obscured by any bedding in the occupation space.

The first part 10 of the bed may be engageable with the second part 12 by sliding movement of the first part relatively to the second part in the direction indicated by arrow 80 in FIG. 2, the respective parts having suitable engagement formations for this purpose. The configuration is such that the sliding movement is limited so that the duct openings 54, 56 align with the duct openings 70, 72 respectively when the formations are fully in engagement with one another. To move the first part from the second part, the first part 30 is slid in the direction opposite to that shown by arrow 80.

Suitable controls are provided for causing operation of the motors 60, 62 as required. A sensing device or devices is provided for determining whether the first part of the bed is occupied by an animal, and a control circuit for controlling the operation of the motors in response to the signals provided by the sensing device(s).

When the first part of the bed is not connected to the second part, the second part may be operated alone, in which case it functions as an air purifier to draw air from the ambient atmosphere, pass it through the filtration means 68, and return it to the atmosphere.

Although as illustrated the apertures 50 are approximately level with the surface of any bedding in the occupation space of the first part of the bed, apertures and suitable ducting may be provided to cause air to flow through the occupation space in any desired manner. For example, air may be drawn from the space at the bottom thereof and returned at the top, to flow downwardly therethrough.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A bed for an animal, comprising a support member; a cover for at least part of the support member, to define and at least partially enclose a space above the support member for occupation by the animal; means for drawing air from the occupation space, and filtration means for removing at least some airborne matter from the withdrawn air.

2. A bed for an animal according to claim 1 wherein air withdrawn from the animal occupation space and passed through the filtration means is returned to the animal occupation space at a part thereof remote from the part at which it has been withdrawn.

3. A bed for an animal according to claim 1 wherein air is withdrawn from the animal occupation space in the vicinity of an upper surface of the support member, on which the animal can rest.

4. A bed for an animal according to claim 1 which comprises a first part including the support member and cover, and a second part to which the first part is removably connected and which includes the means for drawing air from the occupation space, and the filtration means.

5. A bed for an animal according to claim 4 wherein the first part of the bed connects to the second part on the top thereof.

6. A bed for an animal according to claim 5 wherein the first part of the bed is slidable into engagement with the second part thereof.

7. A bed for an animal according to claim 4 wherein the first part of the bed has passages for flow of air to and from the animal occupation space, which passages register with passages in the second part which lead to and from the means for drawing air from the occupation space and the filtration means, when the first part is fitted to the second part.

8. A bed for an animal according to claim 4 wherein the first part of the bed is provided with a door which is able to be moved between and close positions in relation to the support member and cover, and, when in its closed position, constrains an animal within the occupation space.

9. A bed for an animal according to claim 8 wherein the door is completely removable from the first part.

10. A bed for an animal according to claim 9 wherein the second part of the bed provides for storage of the door when not mounted on the first part.

11. A bed for an animal according to claim 4 wherein the first part of the bed is provided with a handle formation.

12. A bed for an animal according to claim 1 comprising at least one fan for drawing air from the occupation space of the bed.

13. A bed for an animal according to claim 12 wherein there are two fans, of which a first fan provides a relatively small air flow and is arranged to operate quietly when an animal is occupying the bed.

14. A bed for an animal according to claim 13 comprising a second fan for causing a greater flow of air, and arranged to operate when an animal is not occupying the bed.

15. A bed for an animal according to claim 14 comprising at least one sensing device, for detecting whether an animal is occupying the bed and for causing operation of the first and second fans in accordance with the detected presence or absence of an animal from the bed.

16. A bed for an animal according to claim 15 wherein a sensing device is operated mechanically.

17. A bed for an animal according to claim 15 wherein a non-contact sensing device(s) is employed.

18. A bed for an animal according to claim 4 wherein the means for drawing air, and the filtration means, are operable when the first part of the bed is not connected to the second part.
